(19) United States
(12) Patent Application Publication
(10) Pub. No.: US 2018/0271735 A1
(43) Pub. Date: Sep. 27, 2018

(54) MULTI-FUNCTIONAL FOAM FITNESS APPARATUS

(71) Applicant: WEDGE EFFECT, LLC, Boca Raton, FL (US)

(72) Inventors: Mark DRUCKER, Boca Raton, FL (US); Marina MILIOS, Deerfield Beach, FL (US); Eleana FRANGEDIS, Boca Raton, FL (US)

(73) Assignee: WEDGE EFFECT, LLC, Boca Raton, FL (US)

(21) Appl. No.: 15/926,649

(22) Filed: Mar. 20, 2018

Related U.S. Application Data
(60) Provisional application No. 62/474,169, filed on Mar. 21, 2017.

(51) Int. Cl. A61H 1/02; A63B 21/00

(52) U.S. Cl. CPC A61H 1/02; A63B 2023/006; A61H 2201/01; A63B 21/00047

(57) ABSTRACT

A multi-layer foam fitness apparatus for use in strength and stretching exercises is provided. The apparatus has a user-engaging portion and a surface-engaging portion. The user-engaging portion is comprised of closed cell EVA foam of a first hardness, and the surface-engaging portion is comprised of a closed cell EVA foam of a second, lesser hardness, wherein the surface-engaging portion is comprised of non-slip memory foam. The user-engaging portion comprises one or more faces, which may be flat, angled, or curved, or some combination of the foregoing.

### CROSS-REFERENCE TO RELATED APPLCIATION

The present application claims the benefit of co-pending U.S. provisional patent application no. 62/474,169 filed Mar. 21, 2017, which is incorporated herein by reference in its entirety

### FIELD OF THE INVENTION

The present invention relates generally to for a piece of fitness equipment. More specifically, the present invention is an apparatus that allows users to target specific muscles and aids in stretching and muscle activation. The apparatus generally concerns a multi-sided block or wedge of a plurality of shapes designed to enhance various stretches and exercises, the apparatus including a plurality of material layers, at least one of which is the material used for the user-engaging side, and one of which is used for the floor-engaging side.

### BACKGROUND OF THE INVENTION

Current devices on the market have simplistic wedge or brick shapes that are not designed to isolate and target specific muscle groups. They are not only inefficient, they are not safe as they tend to slip on surfaces on which they are placed, so they can only be used in certain environments. The present disclosure identifies an apparatus that allows users to target specific muscles and aids in stretching in a wide variety of environments, it being that the apparatus is comprised of a plurality of material layers, wherein one material is used to support the weight of the user performing an exercise or a stretch, and wherein another material is used to interface with a surface to avoid slipping. The multi-material apparatus may comprise a plurality of shapes, but in each embodiment, the shape is designed to support a user's weight in an applicable stretch or exercise to more ideally isolate one or more muscle group(s) as compared to performing the applicable stretch or exercise alone without use of the apparatus.

### BRIEF DESCRIPTION OF THE DRAWINGS

FIG. 1 is an isometric view of a fitness wedge according to a first embodiment.

FIG. 2 is a side elevation view of the fitness wedge of FIG. 1.

FIG. 3 is an isometric view of a fitness wedge according to a second embodiment.

FIG. 4 is a side elevation view of the fitness wedge of FIG. 3.

FIG. 5 is an isometric view of a fitness wedge of according to a third embodiment.

FIG. 6 is a side elevation view of the fitness wedge of FIG. 5.

### DETAILED DESCRIPTION

All illustrations of the drawings are for the purpose of describing various embodiments of the present invention and are not intended to limit scope.

Certain embodiments disclosed herein provide for an apparatus comprised of a plurality of layers of medium to high density closed cell foam. Medium and high density closed cell foam is ideal for fitness equipment because such materials can be easily cleaned and are generally inhospitable to bacterial growth. Medium and high density closed cell foam is also ideal for fitness equipment because they are lightweight, and can be moved or transported by a user very easily. Moreover, medium and high density closed cell foam can be economically fabricated to particular shapes using various methods such as injection molding and thermoforming. In some embodiments, the multi-layer foam apparatus described herein is comprised of a plurality of EVA (ethylene-vinyl acetate) type foams. The multi-layer foam apparatus described herein generally has a user-engaging portion and a surface-engaging portion. According to certain embodiments, the surface-engaging portion is laminated to the user-engaging portion, and the surface-engaging portion is of a lesser hardness rating than the user-engaging portion. According to certain embodiments, the surface-engaging portion is comprised of a non-slip EVA foam which prevents the apparatus from slipping on a floor, or other surface, when a user is using the apparatus. According to certain embodiments, the surface-engaging portion comprises a non-slip EVA foam is considered a “memory foam.” According to certain embodiments, the user-engaging portion has a hardness of approximately 38 degrees shore C. According to certain embodiments, the surface-engaging portion has a hardness of approximately 20 degrees shore C.

According to certain embodiments, the multi-layer foam exercise apparatus has an overall shape which can be described as including at least two components. One of the components is a generally flat-bottom which is located on the surface-engaging portion of the multi-layer foam fitness apparatus. The generally-flat bottom of the surface-engaging portion may optionally include indentations, treads, or other physical relief patterns which allow for enhanced friction and grip between the surface-engaging portion and a floor, or other level surface when a user is using the apparatus. Another component of the shape of the multi-layer foam fitness apparatus is one or more faces of a user-engaging portion which exists at an angle and optionally having a curvature relative to the generally-flat bottom of the surface-engaging portion.

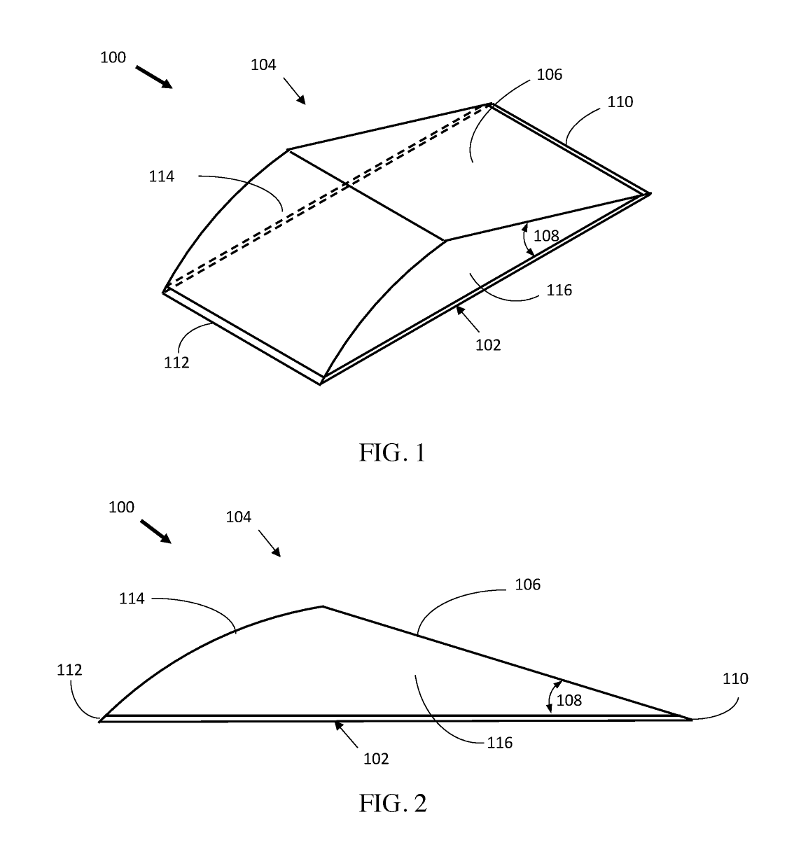

FIGS. 1-2 illustrate a first embodiment of a multi-layer foam fitness apparatus 100. According to an embodiment, apparatus 100 comprises a surface-engaging portion 102 and a user-engaging portion 104. The user-engaging portion further comprises a face 106 angled relative to the surface-engaging portion 102. According to an embodiment, the angle 108 of face 106 is greater than zero but less or equal to 90 degrees, such that the face 106 of the user-engaging portion 104 exists at an incline relative to the surface-engaging portion 102. According to an embodiment, the angled face 106 begins at a distal end 110 of the multi-layer foam fitness apparatus 100 and continues linearly at least part-way toward the proximal end 112 of the apparatus. At a distance at least part way toward the distal end of the apparatus, the flat, angled face of the user-engaging portion ends, and instead forms a convex curved face 114 which continues downwardly until it reaches the proximal end 112 of the apparatus 100. In this embodiment, the user-engaging portion 104 is displaced at varying distances from the surface-engaging portion 102, it being that the user-engaging portion 104 intersects with the surface-engaging portion at both the proximal 112 and distal 110 ends of the apparatus. The varying distance of the user-engaging portion is supported by sidewalls 116 to form an angled wedge at the distal end which transitions to a curved wedge at the proximal end 112. According to an embodiment, the user-engaging portion 104 is comprises of a first foam layer, and the surface-engaging portion 102 comprises a second foam layer wherein the first foam layer is a closed-cell EVA foam and wherein the second foam layer is a softer closed cell EVA foam sufficient to exhibit non-slip properties on level exercise surfaces such as hardwoods, linoleum, or tile flooring. Optionally, the first foam layer of the user engaging portion 104 has a hardness of approximately 38 degrees shore C, and the second foam layer of the surface-engaging portion 102.

According to an embodiment, the multi-layer foam fitness apparatus 100 having at least one angled face 106 and one convex face 114 may be used by a user for a plurality of stretches or exercises. For example, the flat, angled face 106 of the user-engagement portion 104 may support the forward foot of a user when doing lunges. By supporting the forward foot at an angle on the apparatus, the muscles of a user performing a lunge are activated additionally compared to performing a lunge on a level floor. Moreover, by supporting the forward foot of a user performing a lunge at an angle on the apparatus, the user is prevented from over-stretching, because supporting the foot at an angle prevents the forward knee of a user performing a lunge to extend beyond the user's forward foot, which is to be avoided. The flat angled face 106 of the user engaging portion 104 of the apparatus may optionally support a user performing a lateral lunge. As another example, a user may use two apparatuses together under each foot during a squat. In this application, the user's heels are supported by the apparatus and raised relative to the user's toes. By keeping the user's heels raised on the apparatus, the user's weight is forced forward while performing a squat, which keeps the weight away from the heels and more effectively encourages proper form as compared to performing squats on a level floor. As another example, the user may use one or more apparatuses 100 to support the user's feet when performing laying pelvic thrusts. Supporting the foot of a user performing a laying pelvic thrust at an angle prevents the additional leg strain which results when a user performs a lying pelvic thrust on a level floor. As another example, a user may use the flat, angled face 106 of the user-engaging portion 104 of the fitness apparatus to support a user's forearms or elbows when performing a plank. By supporting a user's forearms at an angle relative to a level floor, strain through the elbows is reduced.

Optionally, the angle of the face 106 of the user-engagement portion of the apparatus is an angle 108 which creates additional muscle activation relative to conducting the desired exercise on a level floor. Optionally, the angle 108 of the face 106 of the user-engagement portion 104 of the apparatus 100 is an angle which lessens muscle strain relative to conducting the desired exercise on a level floor. Optionally, the angle 108 of the face of the user-engagement portion of the apparatus is between 10 and 25 degrees. Because the user is being supported at an angle 108 relative to a level floor, the forces imparted by the user on the apparatus includes horizontal forces. However, because the surface-engaging portion 102 of the multi-layer foam fitness apparatus comprises non-slip memory foam, the apparatus does not slide and instead, remains in place to support a user.

According to an embodiment, the convex side 114 of the multi-layer foam fitness apparatus 100 supports a hand or the hands of a user when performing various floor stretches and exercises. Optionally, the curvature of the convex face 114 of the user engagement portion 104 is approximately the same curvature of a human hand when the wrist is extended (when the back of the hand is raised). In this respect, the apparatus 100 provides enhanced support and muscle activation to a user when performing standard push-ups, military push-ups, standard plank, side abductions, leg kick-backs, hamstring curls, leg lifts, downward dog, backbends, and the like. In one embodiment, the convex side 114 of the multi-layer foam fitness apparatus 100 supports a user's back. For example, the apparatus 100 may be placed behind a user's back when performing a seated chest press on an exercise machine.

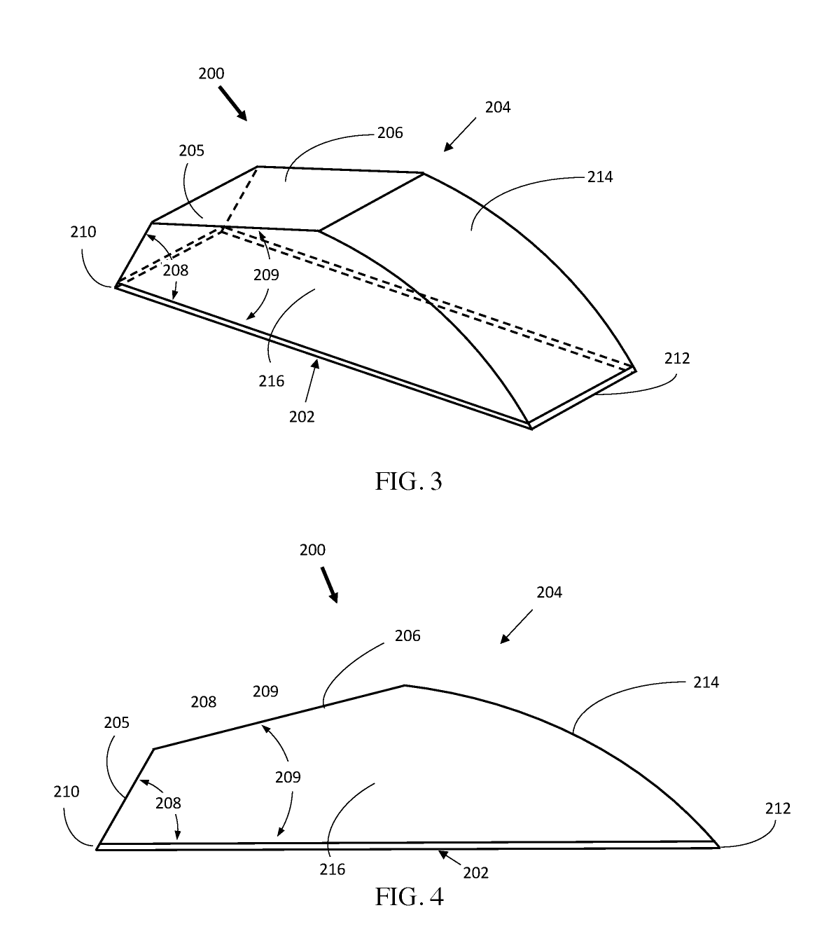

FIGS. 3-4 illustrate a second embodiment of the multi-layer foam fitness apparatus 200 of the present disclosure. In this embodiment, the face of the user engaging portion 204 comprises two flat angled faces 205, 206 in addition to a convex curved face 214. As seen in FIG. 3, the first face 205 extends at an upward angle 208 from the distal end 210 of the apparatus 200 at least part way toward the proximate end 212 of the apparatus 200. The first angled face 205 then transitions to a second angled face 206 which continues to maintain an upward angle 209 compared to the surface-engaging portion of the apparatus, but to a lesser degree as compared to the fist face 205. As with the prior embodiments, the angles 208, 209 of the plurality of faces 205, 206 are greater than zero but less equal to or less than 90 degrees. Then, the second flat angled face 206 of the apparatus 200 continues at least part way to the proximal end 212 of the apparatus 200, where it ends and transitions to a convex curve face 214, which continues downwardly until it terminates where it meets the surface-engaging 202 portion at the proximal end 212 of the apparatus 200. The multi-angled and curved faces 205, 206, 214 of the user engaging portion 204 of the apparatus 200 are supported by sidewalls 216. In this embodiment, the multi-angled faces 205, 206 of the user-engaging portion 204 of the apparatus 200 provide for additional user-interface options, such as a steeper angle for calf stretches, and a raised incline for step-ups.

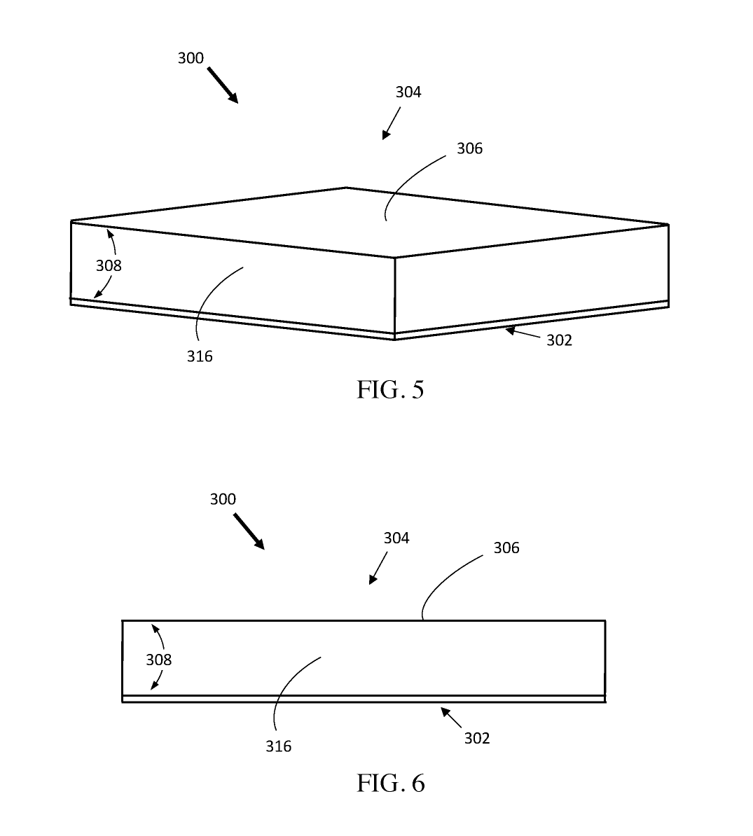

FIGS. 5-6 illustrate a third embodiment of the multi-layer foam fitness apparatus 300 of the present disclosure. In this embodiment, the angle 308 of the face 306 the user-engaging portion 304 relative to the surface-engaging 302 portion is zero, and the face 306 is not curved, meaning that the face 306 of the user-engaging portion 304 and the bottom of the surface-engaging portion 302 lie in parallel planes to one another. The user-engaging portion 304 is displaced a distance from the surface-engaging portion 302 by sidewalls 316, to form a rectangular block or wedge. Optionally, the length of sides displacing the face of the user-engaging portion from the bottom of the surface-engaging portion is approximately 3 inches. According to an embodiment, the rectangular multi-layer foam fitness apparatus 300 may be stacked on top of one another, with the non-slip surface-engaging portion 302 interfacing with the user-engaging portion 304 to form a secure, custom elevation as required by the user for various exercises or stretches such as plyometric box jumps, step ups, elevated planks, crossover push-ups and the like. Using the rectangular multi-layer foam fitness apparatus 300 is advantageous over traditional wooden boxes or metal frames because the fitness apparatus of the present disclosure is modular, lightweight, and easily adjustable by stacking. Also, because the fitness apparatus of the present disclosure comprises foam, it absorbs some of the impact of a user's exercise efforts, thereby lessening stress and strain on muscles and joints through the exercises.

The different faces, angles, and contours allow for multifunctional use for strength training and stretching. A lower density closed cell foam optionally having a pattern is designed to grip hardwood, tile, or linoleum surfaces ensuring the apparatus won't slip. All individuals who participate in strength and flexibility training, as well as yoga would benefit from use of the apparatus. Fitness centers are full of machines and devices that do not deliver the results of effectively targeting a muscle group in a safe manner and eliminating secondary muscle groups, which prevent the individual from cheating and not get optimal results. The apparatus of the present disclosure also assists an individual to perform exercises and stretches that they simply don't have the range of motion or flexibility to accomplish without assistance.

Although a multi-layer foam fitness apparatus of at least three embodiments has been disclosed, alternative embodiments are expressly contemplated within the scope of this disclosure. For example, alternate embodiments include changing the angle of inclination of any of the flat angled faces of the user-engaging portions of the apparatus; changing the radius of curvature of the convex face of the user-engaging portion of the apparatus; changing the curve of the convex face from convex to concave; changing the width or length of the apparatus; changing the hardness or density of the multiple foam layers that comprise the apparatus; changing the sidewalls from straight perpendicular to inclined, convex, or concave, to have at least 4 different surfaces to use by a user.

Many alterations and modifications may be made by those having ordinary skill in the art without departing from the spirit and scope of the embodiments disclosed and described herein. Therefore, it is understood that the illustrated and described embodiments have been set forth only for the purposes of examples and that they are not to be taken as limiting the embodiments as defined by the following claims. For example, notwithstanding the fact that the elements of a claim are set forth below in a certain combination, it must be expressly understood that the embodiments include other combinations of fewer, more or different elements, which are disclosed above even when not initially claimed in such combinations.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the elements disclosed. The claims are thus to be understood to include what is specifically illustrated and described above, what is conceptually equivalent, what can be obviously substituted and also what incorporates the essential idea of the embodiments.

What has been described above includes examples of one or more embodiments. It is, of course, not possible to describe every conceivable combination of components or methodologies for purposes of describing the aforementioned embodiments, but one of ordinary skill in the art may recognize that many further combinations and permutations of various embodiments are possible. Accordingly, the described embodiments are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A multi-layer foam fitness apparatus comprising:
a proximal end and a distal end;
a first foam layer comprising a user-engaging portion; and
a second foam layer comprising a surface-engaging portion.

2. The apparatus of claim 1, wherein the user-engaging portion further comprises a first face existing at an angle in comparison to the surface-engaging portion

3. The apparatus of claim 2, wherein the user-engaging portion further comprises a second face existing in a convex curve.

4. The apparatus of claim 3, wherein the user-engaging portion further comprises a third face existing at an angle in comparison to the surface-engaging portion.

5. The apparatus of claim 3, wherein the third face extends at an angle between the first face and the second face.

6. The apparatus of claim 2, wherein the angle of the first face is zero.

7. The apparatus of claim 2, wherein the angle of the first face is between 10 and 75 degrees.

8. The apparatus of claim 2, wherein the angle of the first face is approximately 16.83 degrees.

9. The apparatus of claim 3, wherein the angle of the first face is approximately 60.95 degrees and the angle of the second face is approximately 14 degrees compared to the surface-engaging portion.

10. The apparatus of claim 3, wherein the curvature of the convex curve is approximately the same as a human hand when a wrist is extended.

11. The apparatus of claim 1, wherein the first foam layer comprises a closed-cell EVA foam of a first hardness, and the second foam layer comprises a closed-cell EVA foam of a second hardness, and wherein the second hardness is less than the first hardness.

12. The apparatus of claim 11, wherein the second foam layer is a non-slip memory foam.

13. The apparatus of claim 12, wherein the surface-engaging portion includes physical relief patterns which create additional grip between the surface engaging portion and a surface.

14. The apparatus of claim 11, wherein the first hardness is approximately 38 degrees shore C and wherein the second hardness is approximately 20 degrees shore C.

15. The apparatus of claim 3, wherein the first face extends from the distal end until at least part way to the proximal end, and where the first angled face transitions to the second curved face part-way to the proximal end, and where the curved face continues until reaching the proximal end.

16. The apparatus of claim 2, wherein the first face is displaced a distance from the surface-engaging portion by a plurality of sidewalls.

17. The apparatus of claim 16, wherein the surface-engaging portion and first face and sidewalls of the user-engaging portion form a rectangular block.

18. The apparatus of claim 16, the length of sides displacing the face of the user-engaging portion from the surface-engaging portion is approximately 3 inches.

19. The apparatus of claim 18, further comprising a modular plyometric box; formed by stacking a plurality of apparatuses on top of one another, wherein the surface-engaging portion interfaces with the user-engaging portion to form a secure, custom-height plyometric box.
